(19) United States
(12) Patent Application Publication
(10) Pub. No.: US 2021/0291351 A1
(43) Pub. Date: Sep. 23, 2021

(54) Bottleneck Spatula

(71) Applicant: Richard John McCormick, Newport Beach, CA (US)

(72) Inventor: Richard John McCormick, Newport Beach, CA (US)

(21) Appl. No.: 16/826,224

(22) Filed: Mar. 21, 2020

(51) Int. Cl. B25J 1/04; A45D 34/00; B65G 65/36

(52) U.S. Cl. CPC B25J 1/04; A45D 34/00; B65G 2201/0244; A45D 2034/002; B65G 65/36

(57) ABSTRACT

One embodiment of an elongated, thin, flat, angled device for an improved bottle spatula having a handle (10) section which merges into an angled bend (14) section before merging into a spatula end (20). Other embodiments are described and shown.

### BACKGROUND OF THE INVENTION

This invention relates to product packaging containers, specifically, a device which removes the residual product from the vicinity under and around the inside neck of a bottle.

Today's consumer product packaging and containers do an admirable job of holding liquids of all various viscosity's for the consumer. The immense amount of product that is manufactured around the world, then shipped in containers, then broken down in bulk, sold online or through retail stores is nothing short of amazing. One problem for the consumer that does exist is the amount of residual product left inside consumer bottles that is never used by the consumer. Maybe it went beyond the expiration date, was ruined, or otherwise wasted but a small amount is never used because the consumer thought the container was empty. The odds are that there was some product left inside the bottle.

There are products such as small spatulas on the end of long handles that help the consumer remove any leftover product at the bottom and on the sides—for example, in U.S. Pat. D833,066 to Cooley (2018), D785,238 to Silva (2017), and D667,165 to Strobe (2012), but they all are very similar, and, due to the long handle, don't allow one to get under the neck, shoulders, and ceiling of the bottle.

Today's cosmetic spatulas suffer from several disadvantages:

(a) The handles must be long enough to reach the bottom and sides of the bottle which makes them harder to control.

(b) The end of the spatula must be small to fit through the bottleneck but this requires more trips going into and back out of the bottle to scoop out the product.

(c) The total area of the inside of the bottle can be quite large which requires many times going into and out of the bottle to scoop out the product.

(d) The small, flat end is not ideal for lifting and scooping the product.

(e) The area at the bottom and sides of the bottle is large and one cannot see where there is residual product left, unless in the unlikelihood that the bottle is clear.

(f) Wasted time scraping product out of a much larger area.

(g) More difficult to remove leftover contents as one is not simply using gravity to let the product come towards the bottle opening.

(h) The spatula end is not angled, so it is difficult to scoop the product up off the bottom of the bottle without, say, a ninety-degree angle bend at the spatula end.

### ADVANTAGES

Accordingly, several advantages of one or more aspects are as follows: to provide a bottle spatula that is easy to use, quick and efficient, inexpensive and pays for itself quickly, saves time and money over a person's lifetime, conserves ingredients and raw materials such as plastics, and doesn't leave any leftover product in the bottle. These and other advantages of one or more aspects will become apparent from a consideration of the ensuing description and drawings.

### SUMMARY

In accordance with one embodiment, a spatula comprises a handle, an angled neck, and a flat end.

### DRAWINGS—FIGURES

In the drawings, closely related figures have the same number but different alphabetic suffixes.

FIG. 1 is a perspective view of a bottleneck spatula device inside a bottle with numbered parts, and with a standard thirty-degree angle bend and straight spatula end of one embodiment.

FIG. 2A is a perspective view of a spatula device with an easy grip and turn handle top and rounded spatula end of another embodiment.

FIG. 2B shows a perspective view of a spatula device with a short spatula, a ninety-degree bend, and a raised spatula end of another embodiment.

FIG. 2C shows a perspective view of a spatula device with two built-in spatulas (one at each end of the device) with different spatula lengths, different bend angles, and different spatula ends of another embodiment.

FIG. 3 shows a perspective view of a spatula device inside a bottle with an extended spatula of another embodiment.

FIG. 4 shows a perspective view of a spatula device inside a bottle with an extended spatula for scraping the bottom of the container of another embodiment.

FIG. 5 shows a perspective view of a spatula device inside a bottle with a handle that extends straight down to the bottom of the bottle and a ninety-degree angle bend.

### DRAWINGS—REFERENCE NUMERALS

10 Handle
12 Bottleneck
14 Bend
16 Bottle Shoulder
18 Bottleneck Spatula
20 Spatula End
22 Neck Opening
24 Side Scraper
26 Bottom Scraper

### DETAILED DESCRIPTION

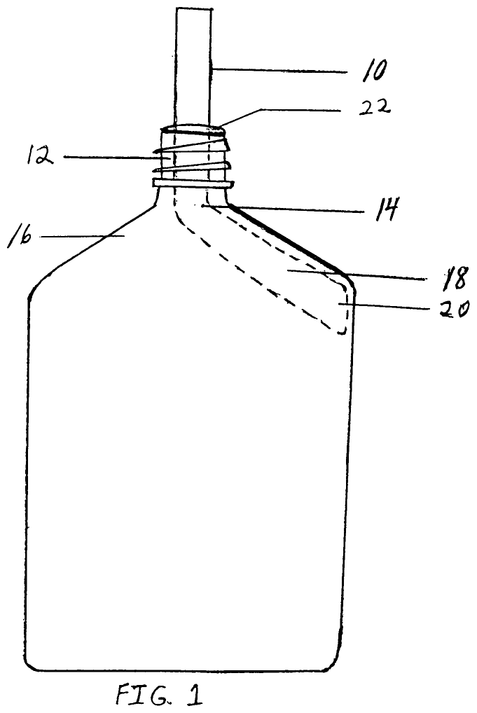

### FIG. 1—First Embodiment

One embodiment of the Bottleneck Spatula (18) is illustrated in FIG. 1 (front view). Other views include 2A to 2C (perspective views). The Bottleneck Spatula (18) is shown to be a mostly flat or round, bent, elongated device that allows it to fit inside a neck of a bottle, collapsible tube, or other types of product packaging containers. The device has a thin base edge consisting of a flexible sheet of material which can be bent without breaking. In one embodiment, the base is a flexible plastic, such as polyethylene. The base can consist of any other material that can be repeatedly bent and not break, such as rubber, polypropylene, various plasticized materials, etc.

At one end is the handle (10) which is generally thin and elongated. The handle (10) extends until it eventually is bent at the bend (14) at an approximately thirty-degree angle. This continues to the spatula end (20) which is generally flat and can widen and/or be concave to act as a digging scoop to collect residual product left in, under, or around the region of the bottleneck (12).

The handle (10) can be the same width of the spatula end (20) or smaller to get through the bottleneck opening (22). Most handles are approximately 0.5 cm to 1 cm wide. The length of the handle (10) is generally 5 cm to 9 cm.

The elbow or bend (14) is generally around a thirty-degree angle as it runs toward the spatula end (20) as that is the most common angle of most bottle shoulders (16), the section descending from the bottleneck (12).

The widest part of the device is the spatula end (20) and is generally anywhere from 0.7 cm in width to get into the smallest bottleneck openings (22), such as those on a collapsible tube of toothpaste (0.8 to 1 cm), to 1.5 cm or more for getting into an economy size bottle of shampoo which may have a neck opening (22) of 2.5 cm to 3 cm or more.

The length of the spatula (18) is generally 1 cm to 4 cm but can extend down the side of the bottle with a length of 17 cm or more—depending on the height of the bottle.

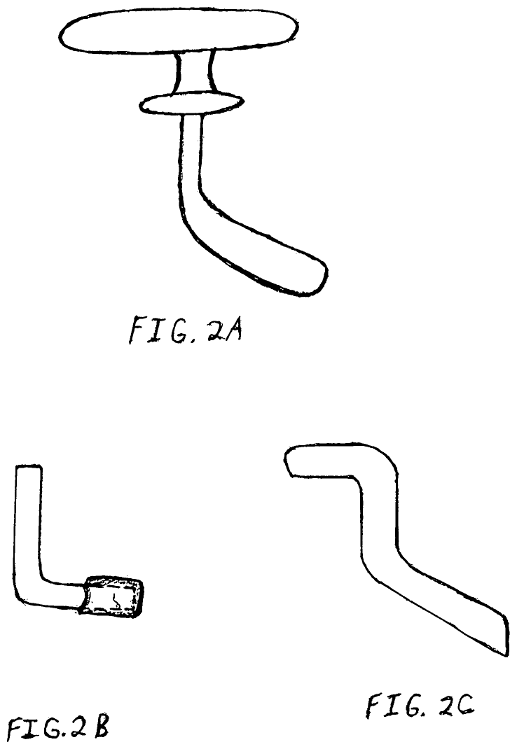

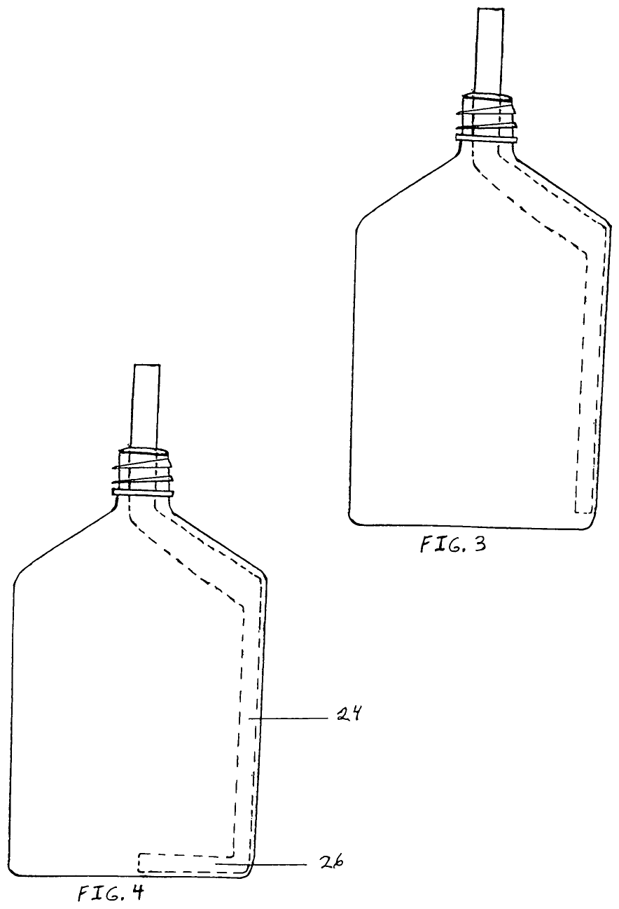

### FIG. 2A

FIG. 2A shows a spatula (18) with an easy-grip top handle. The bend (14) is at an angle of approximately thirty-degrees which is standard and it has a rounded spatula end (20).

### FIG. 2B

FIG. 2B shows a spatula (18) with a standard straight handle and a close to ninety-degree angle bend (14). The spatula end (20) has a raised tip which allows it to collect more product residue left under the bottle shoulder (16) area.

### FIG. 2C

FIG. 2C is two spatulas in one. The one on the bottom has an approximately thirty-degree angle bend (14) and a straight spatula end (20) while the one on the top is short and has a ninety-degree angle bend (14).

### FIG. 3

FIG. 3 shows a spatula device (18) which extends from the bottle shoulder down the side of the bottle and stops near the bottom of the bottle. This particular device allows for scraping product from the sides of the bottle as well as the shoulder region.

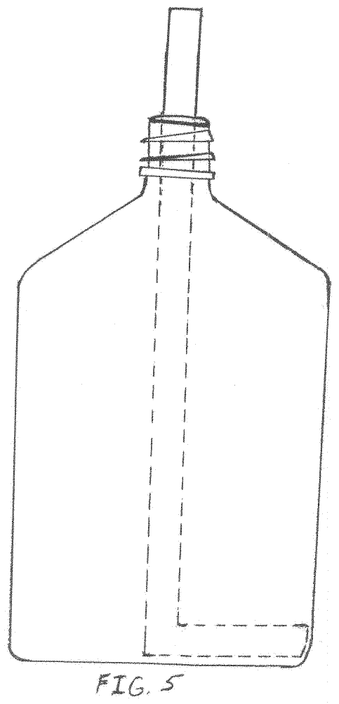

### FIG. 4

FIG. 4 shows a spatula device (18) which extends from the bottom of the sides along the bottom to scrape residual product from the bottom, the sides, and the shoulder of the bottle.

### FIG. 5

FIG. 5 shows a spatula device (18) which extends straight down in the middle of the bottle and makes a ninety-degree angle to the side of the bottle. This particular device allows for the bottom of the bottle to be scraped of residual product.

### Operation—FIGS. 1 and 2A to 2C

The simple manner to get the most product out of product packaging bottles and containers is with the use of a bottleneck spatula (18). You can dispense the product through its usual spout or bottleneck (12) but when the bottle gets low on product and it is not dispensing its full proper amount, it will sputter and make a sneezing sound. Take the cap off and hit the opening (where the product exits) against your open palm to force the product out. If it's a pump container, you can also take the pump cap off and slide your palm down the straw of the pump to obtain the product. This will get you a couple uses, but you are still not out of the product. This is when a bottleneck spatula (18) comes in handy.

When the bottle starts to sneeze and sputter, close the lid or put the cap back on. Hold the bottle upright and snap it down as though cracking a whip. This will force the product from the bottom of the bottle up towards the exit spout. Take off the top or flip open the lid and you should be able to get the product out of the bottle now. Once you get enough shampoo or whatever product, put the cap back on and keep the product in an upside-down position wedged between two walls in the shower or a shower daddy, etc. Due to gravity, the next time you use the product, there should be enough product settled down toward the exit spout that you should be able to get enough product for a few more uses.

When you are no longer getting enough product and you think it's all gone, it's not. This is when the Bottleneck Spatula (18) comes into play. Unscrew or flip open the top of the product container and place the spatula end (20) into the bottleneck (12). Use the handle (10) to pull the spatula (18) up so that it is pressing up against the underside of the bottle shoulder (16). Use the handle (10) to rotate the spatula (18) around the underside of the bottle shoulders (16). The spatula (18) will collect any residual product. Take the spatula (18) out of the bottle and wipe the residual product onto the palm of your hand. Place the cap back on the bottle and store the product upside down in a corner, in a shower daddy, medicine cabinet, etc. until its next use. Use the product. You should get at least a few more uses out of this remaining product.

### FIGS. 2A to 2C, 3, 4, 5—Additional Embodiments

Additional embodiments are shown in FIGS. 2A, 2B, and 2C. In FIG. 2A it has an easy-grip handle top which allows the user to turn the device easier and to keep the spatula (18) pressed up against the underside of the bottle shoulder (16) as it is being rotated. In FIG. 2B it has a raised and concave spatula end (20) which allows for a greater collection of residual product. In FIG. 2C it has two different spatulas (18) in one device which have different spatula ends (20), different lengths, and different bends (14) to accommodate the wide variety of bottles in the market.

FIGS. 3 and 4 show different extension lengths of the spatula ends (20). FIG. 3 is used to scrape the shoulder (16) and side (24) of the bottle. To obtain the residual product, the user would pull the handle (10) so that the spatula (18) is scraping against the side (24) of the bottle. FIG. 4 has a longer spatula end (20) than the one in FIG. 3 and can be used to scrape the shoulder (16), side (24), and bottom (26) of the bottle. FIG. 5 shows a long, straight handle that extends to the bottom of the bottle before it turns ninety-degrees and is used for scraping the bottom (26) of the bottle. For bottom scraping (26), the user would push down on the handle (10) to accumulate the product residue off the bottom of the bottle.

### Advantages

From the description above, a number of advantages of some of the embodiments of my Bottleneck Spatula become evident:

(a) The handle is much shorter and easier to control than most cosmetic spatulas.

(b) The area being scraped of product around the bottleneck region is much smaller so the user does not have to use the spatula as often.

(c) It is much simpler as the consumer uses gravity to confine the product into an area that is closer to the opening and, thus, much easier to get to.

(d) The spatula is angled to the contour of the bottle shoulder which allows the user to easily scoop up the product.

(e) It saves time scraping product from the bottle because the spatula fits the contour of the inside of the bottle. All the user has to do is turn the handle.

(f) More residual product will be collected as it is not spread over a wide area.

(g) Less expensive for the consumer who will have used the same amount of product with fewer purchases.

(h) Less waste of natural resources as fewer raw materials are used to contain the same amount of product.

(i) Less waste as fewer ingredients will be used in the manufacturing of the products.

(j) Less energy is required to manufacture these billions of product packaging containers.

(k) Less landfill space is required, so this helps to save the planet.

(l) Can scrape the entire inside of the bottle without leaving behind hardly any product.

### Conclusion, Ramifications, and Scope

Accordingly, the reader will see that the Bottleneck Spatula devices of the various embodiments can be used to save time, money, and quickly and efficiently remove the residual product from the neck and shoulder area of product packaging containers, all while reducing the amount of energy and space used for landfills and number of plastic bottles, raw materials, and ingredients used. All of these will help save the planet.

There is no excuse not to use a Bottleneck Spatula as it will save time and money for the customer and consumer throughout their lifetimes—all at a nominal cost.

While the above description contains specificities, they should not be construed as limiting the scope of the embodiments but as merely providing illustrations of some of several embodiments. For example, the spatula end may have different shapes and sizes. They may be concave or flat. The handle may be round, flat, oval, etc. The angle of the bend may be any degree angle that works to get the product out from the neck and shoulder area.

There are various possibilities with regard to how the device is designed and shaped, therefore, the scope should be determined not by the illustrated embodiments, but by the claims and their legal equivalents.

I claim:

1. A hand-held utensil device comprising: an elongated handle first section which merges into an angled second section, which merges into an elongated, flat third section.

2. The device of claim 1 wherein said device is composed of polyethylene.

3. The device of claim 1 wherein said angled second section is angled at thirty-degrees.

4. The device of claim 1 wherein said flat third section is concave.

5. The device of claim 1 wherein said device is composed of polypropylene.

6. The device of claim 1 wherein said device is made of plastic material.

7. The device of claim 1 wherein said device is made of bendable plastic.

8. The device of claim 1 wherein said third section is composed of rubber.

9. The device of claim 1 wherein said third section is wider than said handle and extends back toward said angled section.

10. The device of claim 1 wherein said third section is attached at a ninety-degree angle to said handle.

11. The device of claim 1 wherein said flat end is curved.

12. The device of claim 1 wherein said third section is detachable from said second section and interchangeable with different third section pieces.

13. The device of claim 1 wherein said second section is detachable from said first section and is interchangeable with different third section pieces.

14. The device of claim 8 wherein said rubber is disposed around said third section.

15. A method of removing the residual product from a bottle comprising the steps of:
removing a cap from of a product container, hitting the spout opening (where the product exits) in a downward movement against an open palm to force the product out and into said palm, replacing the cap on the container, and storing the container in an upside-down position.

16. The method of claim 15 comprising holding the bottle upright, snapping it in a downward motion as though cracking a whip, taking the cap off or opening the flip-top lid, squeezing the container to remove the product, putting the cap back on the container, and storing the container in an upside-down position.

17. The method of claim 15 comprising taking off the cap or opening the flip-top lid, placing a spatula in through the bottleneck, using the handle to pull the spatula up, so that it is pressing against the underside of the bottle shoulder, using the handle to rotate the spatula around to scoop residual product from the bottle, taking the spatula out of the bottle, wiping the product onto one's fingers or the palm of one's hand, placing the cap back onto the bottle, and storing the container upside down.

18. The method of claim 15 comprising of pushing down or sideways on the handle so that the spatula will press against the bottom of the bottle or the side of the bottle, and then turning the handle to scoop the residual product from the bottom of the bottle and side of the bottle.

19. The method of claim 15 further comprising taking a pump cap off a pump bottle, sliding one's fingers or palm down the straw to collect the residual product, placing the pump cap back onto the bottle, and storing the container upside down.
